(19) United States
(12) Patent Application Publication
(10) Pub. No.: US 2010/0011613 A1
(43) Pub. Date: Jan. 21, 2010

(54) Apparatus for drying hearing aids

(76) Inventor: Kunibert Husung, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/503,108

(22) Filed: Jul. 15, 2009

(30) Foreign Application Priority Data
Jul. 21, 2008 (DE) 10 2008 033 982.2
Sep. 15, 2008 (DE) 10 2008 047 220.4

(51) Int. Cl. F26B 3/02; F26B 21/00; F26B 25/06

(52) U.S. Cl. 34/443; 34/82; 34/218

(57) ABSTRACT

The invention relates to an apparatus for drying hearing aids. According to the invention, the drying apparatus includes a housing and in the housing a hearing aid shell for inserting the hearing aid and a fan, with the fan accelerating air by means of an electro-aerodynamic pump. The electro-aerodynamic pump is advantageously embodied to generate gas ions and to accelerate the gas ions through an electrical field. The electro-aerodynamic fan is advantageous in that it requires little space and, except for the air flow, operates at a low noise level.

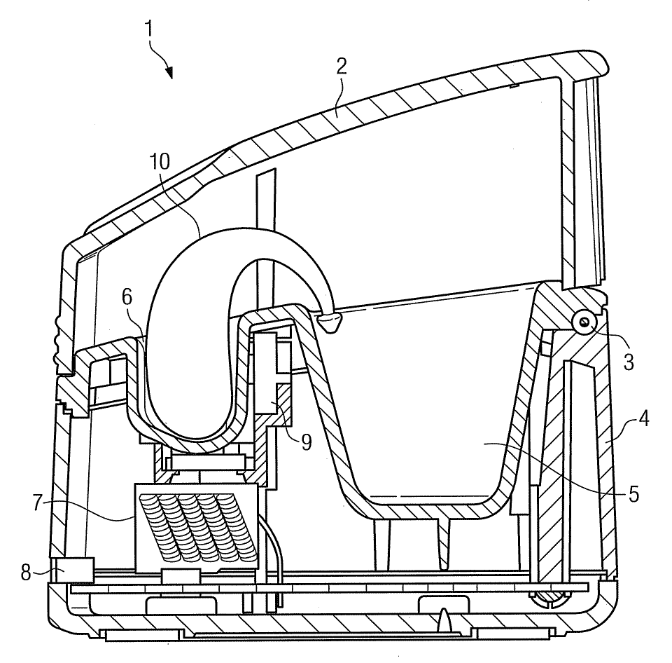

### CROSS REFERENCE TO RELATED APPLICATIONS

This application claims priority of German application No. 10 2008 033 982.2 filed Jul. 21, 2008 and priority of German application No. 10 2008 047 220.4 filed Sep. 15, 2008, both of the applications are incorporated by reference herein in their entirety.

### FIELD OF THE INVENTION

The invention relates to an apparatus for drying hearing aids.

### BACKGROUND OF THE INVENTION

Hearing aids become damp during wear, as a result in particular of sport activities and the effect of weather influences. Hearing aids should be cleaned after use, whereby it is likewise possible for moisture to have an effect.

The same applies to the wearable devices for treating tinnitus hearing damage which are comparable with hearing aids. Devices for tinnitus therapy, such as hearing aids, are therefore likewise to be understood below under the term “hearing aid”.

To ensure an efficient operation over a lengthy period of time, hearing aids should be dried after use or cleaning. To this end, it is known to use so-called desiccant capsules, which act in a strongly hydrophilic fashion, i.e. absorb moisture and dehumidify the hearing aid. It is also known to place hearing aids for drying in drying devices comprising a heater, e.g. an integrated resistance heater, in order to effect a drying process by means of heating. Air movement in these devices is exclusively effected by means of convection, i.e. the rise of hot air.

To prevent hot spots, a motorized fan which forces the air to circulate could advantageously be provided. Motorized fans are however mostly relatively large and usually also have the disadvantage of significant noise development. They are therefore not widespread in drying apparatuses for hearing aids.

The publication JP 08018356 A discloses an apparatus for filtering air. A corona discharge ionizes particles which are then accelerated toward an anode and are removed by a filter positioned behind the anode. The acceleration of the ions generates an ion wind, which is deviated through a bypass.

### SUMMARY OF THE INVENTION

The object underlying the invention is to specify a drying apparatus for a hearing aid, which requires little space, functions reliably and operates at a low noise level.

One basic idea behind the invention consists in specifying an apparatus for drying a hearing aid, which includes a housing, and in the housing a hearing aid shell for inserting the hearing aid and a fan, with the fan accelerating air by means of an electro-aerodynamic pump.

An electro-aerodynamic pump is embodied so as to generate gas ions and to accelerate the gas ions through an electrical field. This electro-aerodynamic operating principle can be realized with few electronic parts, basically only a voltage generator, an electrode pair for ionization and an electrode pair for accelerating air and/or gas atoms and molecules are needed. The small number of functional parts ensures high reliability.

The electro-aerodynamic pump does without moveable parts. This increases the reliability of the fan, since the mechanical sensitivity of moveable parts, e.g. rotating fan and associated bracket, is avoided. Furthermore, the avoidance of moveable parts also reduces the operating noises of the fan. The electro-aerodynamic pump does not generate any appreciable operating noise in comparison with the noise of the air flow generated. The pump operates not least very efficiently, so that a comparatively smaller installation size of the pump allows for comparatively strong air flows to be generated. As a result, a small space-saving fan is sufficient to generate an adequately strong air flow in order to dry hearing devices.

A further advantageous development of the invention provides for a supply air opening and a discharge air opening to be provided in the housing and for the interior of the apparatus to be molded such that an air flow generated by the fan is routed from the supply air opening through the hearing aid shell to the discharge air opening. This ensures that a hearing aid inserted for drying purposes is surrounded by a circulating air flow. At the same time, air, which has already absorbed moisture during the drying process, can escape through the discharge air opening and unused air can flow continuously through the supply air opening. The thus ensured inflow of unused, dry air renders a heater for additionally increasing the drying power unnecessary.

A further advantageous development of the invention provides for an accessory shell to be provided in the housing and for the interior of the apparatus to be molded such that an air flow is routed from the supply air opening through the accessory shell to the discharge air opening. This ensures that accessories can also be dried, e.g. hearing tubes or auditory canal inserts.

A further advantageous development of the invention provides for the supply air opening to be provided with a filter element, by means of which inflowing air is filtered and which has an air flow resistor, by means of which the air quantity flowing in is reduced by at least 25% per unit of time. On the one hand, the filter element prevents dirt particles, e.g. dust particles, from flowing in in significant quantities. On the other hand, the inflowing air flow can be restricted in terms of quantity and a higher circulating airflow can at the same time be maintained in the interior of the apparatus. The quantitative restriction of the inflowing air inevitably also restricts the quantity of the outflowing air and as a result reduces the operating noise of the apparatus. The significant air flow in the interior can at the same time achieve a greater drying power, as a result of which it is possible to dispense with an additional heater for increasing the drying power.

A further advantageous development of the invention provides for an additional embodiment as a charging station for charging rechargeable batteries in a hearing aid inserted into the hearing aid shell. As a result, the drying of the hearing aid, which is to take place regularly, can take place at the same time as and in collaboration with the recharging process which is likewise needed regularly. This improves user friendliness since separate user treatments are not needed for the two processes. In addition, the time required is reduced since the separate processes take place at the same time.

### BRIEF DESCRIPTION OF THE DRAWINGS

Further advantageous developments of the invention result from the dependent claims and the subsequent description of an exemplary embodiment with reference to a figure. The figure shows an apparatus for drying a hearing aid.

### DETAILED DESCRIPTION OF THE INVENTION

Figure shows a schematic sectional image of an apparatus 1 for drying a hearing aid. The apparatus includes a housing 4, which is closed by a cover which can be pivoted and/or swiveled about an axis 3. A molded part, into which a hearing aid shell 6 and an accessory shell 5 are countersunk, is located within the apparatus 1 and/or the housing 4. The hearing aid shell 6 is used for insertion of a hearing aid 10 for drying purposes. Accessories of the hearing aid, e.g. hearing tube or auditory canal inserts, can likewise be inserted into the accessory shell 5 for drying purposes.

In an advantageous embodiment, the apparatus 1 is not only used for drying but also for recharging rechargeable batteries in the hearing aid 10. In such a variant, corresponding charging contacts are provided in the hearing aid shell 6 as well as a charge current generator in the housing 4, which are however not shown in the drawing.

The apparatus 1 includes an electro-aerodynamic fan 7 as an essential element. This operates without moveable parts and thus also without a motor. Instead, gas atoms and molecules are ionized, which generally takes place by means of relatively strong electrical fields. Direct current fields as well as alternating current fields can basically be used herefor. However, alternating current fields generate relatively strong and extensive interference signals, which could interfere with other electronic devices. The use of direct current fields is thus preferred.

The ionized gas particles are accelerated through an additional electrical field. This acceleration firstly effects a flow of ionized gas particles, e.g. air particles, in the direction specified by the electrical field. The generated air flow is nevertheless increased such that the accelerated charged particles carry along uncharged gas particles which are not accelerated by the electrical field itself. An intensive air flow is produced as a result.

With the ionization processes in the air, minimal quantities of ozone are advantageously generated, which could advantageously bring about disinfection, albeit to a limited extent.

The electro-aerodynamic fan 7 effects a circulation of air within the apparatus 1. The apparatus 1 is molded here such that air passes through the hearing aid shell 6. Advantageously it likewise passes through the accessory shell 5. Due to the high efficiency of the active principle of the electro-aerodynamic fan 7, an air flow with a large flow quantity can be generated here in spite of the small installation size of the fan 7. Due to the significant circulating air quantity, there is a strong drying effect, thereby dispensing with the need for an additional heater.

A supply air opening 8 is provided in order to restrict the increasing air humidity during the drying process. A minimal quantity of unused, i.e. non-humidified air, continuously flows in through the supply air opening 8. To this end, it is essential to provide an air vent, which is realized as a discharge air opening 9. In order to clean the inflowing air so that no dust particles flow in for instance, a filter element is provided in the supply air opening. The filter element simultaneously restricts the quantity of inflowing air, so that despite strong air circulation in the interior of the apparatus 1, only restricted inflow and outflow is provided. As a result, the operating noise of the apparatus 1 is kept at a low level.

The invention can be summarized as follows: The invention relates to an apparatus 1 for drying hearing aids 10. According to the invention, the drying apparatus 1 includes a housing 4 and in the housing 4 a hearing aid shell 6 for inserting the hearing aid and a fan 7, with the fan 7 accelerating air by means of an electro-aerodynamic pump. The electro-aerodynamic pump is advantageously embodied to generate gas ions and to accelerate gas ions through an electrical field. The electro-aerodynamic fan 7 is advantageous in that it requires little space and, except for the air flow, operates at a low noise level.

1.-6. (canceled)

7. An apparatus for drying a hearing aid, comprising:
a housing;
a hearing aid shell arranged in the housing for inserting the hearing aid; and
an electro-aerodynamic fan arranged in the housing that accelerates air for drying the hearing aid.

8. The apparatus as claimed in claim 7, wherein the electro-aerodynamic fan accelerates air by an electro-aerodynamic pump.

9. The apparatus as claimed in claim 8, wherein the electro-aerodynamic pump generates gas ions and accelerates the gas ions through an electrical field.

10. The apparatus as claimed in claim 7, further comprising a supply air opening and a discharge air opening arranged in the housing.

11. The apparatus as claimed in claim 10, wherein an air flow generated by the electro-aerodynamic fan is routed in an interior of the apparatus from the supply air opening through the hearing aid shell to the discharge air opening.

12. The apparatus as claimed in claim 11, further comprising an accessory shell arranged in the housing.

13. The apparatus as claimed in claim 12, wherein the air flow generated by the electro-aerodynamic fan is routed in the interior of the apparatus from the supply air opening through the accessory shell to the discharge air opening.

14. The apparatus as claimed in claim 10, wherein the supply air opening comprises a filter element for filtering inflowing air.

15. The apparatus as claimed in claim 14, wherein the filter element comprises an air flow resistance for reducing an air quantity of the inflowing air by at least 25% per unit of time.

16. The apparatus as claimed in claim 7, further comprising a charging station inserted into the hearing aid shell for charging rechargeable batteries in the hearing aid.

17. The apparatus as claimed in claim 16, wherein the drying of the hearing aid takes place at a same time as and collaborates with a process of the charging.

18. A method for drying a hearing aid, comprising:
providing a housing in the hearing aid;
arranging a hearing aid shell in the housing;
inserting the hearing aid in the hearing aid shell;
arranging an electro-aerodynamic fan in the housing;
accelerating air by the electro-aerodynamic fan; and
drying the hearing aid with the air.
